(19) United States
(12) Patent Application Publication
(10) Pub. No.: US 2024/0342996 A1
(43) Pub. Date: Oct. 17, 2024

(54) SYSTEM AND METHOD FOR DYNAMICALLY CONTROLLING A THERMOSET THREE-DIMENSIONAL PRINTER BASED UPON PRINT PARAMETERS OF DIFFERENT MATERIALS

(71) Applicant: PPG Industries Ohio, Inc., Cleveland, OH (US)

(72) Inventors: Kerianne Merceline Dobosz, Pittsburgh, PA (US); Bryan William Wilkinson, Pittsburgh, PA (US); Eric Scott Epstein, Pasadena, CA (US); Michael Anthony Bubas, Pittsburgh, PA (US); Cynthia Kutchko, Pittsburgh, PA (US)

(73) Assignee: PPG Industries Ohio, Inc., Cleveland, OH (US)

(21) Appl. No.: 18/683,807

(22) PCT Filed: Jul. 7, 2022
(86) PCT No.: PCT/US2022/073500

§ 371 Date: Feb. 15, 2024

Related U.S. Application Data
(60) Provisional application No. 63/234,395, filed on Aug. 18, 2021.

(51) Int. Cl. B29C 64/393; B29K 21/00; B33Y 50/02; B33Y 70/00

(52) U.S. Cl. CPC B29C 64/393; B33Y 50/02; B33Y 70/00; B29K 2021/006

(57) ABSTRACT

A computer system (110) for controlling a thermoset printer (100) to create desired material attributes comprises one or more processors (210) and one or more computer-readable media (220) having stored thereon executable instructions that when executed by the one or more processors configure the computer system to perform various acts. The computer system may receive an indication of one or more thermoset materials that are to be used by the thermoset printer (100) to print a target object (120). The computer system (110) may also access a material attribute dataset that describes different material properties of the one or more thermoset materials during printing. Based upon the material attribute dataset, the computer system determines a particular extrusion configuration for the one or more thermoset materials and generates a command to cause the thermoset printer to implement the particular extrusion configuration while printing the target object (120).

### GOVERNMENT RIGHTS

This invention was made with government support under Government Contract No. W911NF-17-20227, awarded by the U.S. Army Contracting Command on behalf of the U.S. Army Research Laboratory (ARL). The government has certain rights in the invention.

### BACKGROUND OF THE INVENTION

### 1. Technical Field

The present invention relates to computer control of three-dimensional printing methods that use coreactive materials. In particular, the present invention relates to dynamically controlling extrusion configurations of a thermoset three-dimensional printer based upon different materials that are to be used by the three-dimensional printer.

### 2. Background and Relevant Art

Three-dimensional (3D) printing, also referred to as additive manufacturing, has experienced a technological explosion in the last several years. This increased interest is related to the ability of 3D printing to easily manufacture a wide variety of objects from common computer-aided design (CAD) files. In 3D printing, a composition is laid down in successive layers of material to build a structure. These layers may be produced, for example, from liquid, powder, paper, or sheet material.

In conventional configurations, a 3D printing system utilizes a thermoplastic material. The 3D printing system extrudes the thermoplastic material through a heated nozzle on to a platform. Using instructions derived from a CAD file, the system moves the nozzle with respect to the platform, successively building up layers of thermoplastic material to form a 3D object. After being extruded from the nozzle, the thermoplastic material cools. The resulting 3D object is thus made of layers of thermoplastic material that have been extruded in a heated form and layered on top of each other.

There are many ways in which 3D printing can be improved. These improvements may comprise faster printing, higher resolution printing, more durable end products, among many other desired outcomes.

### BRIEF SUMMARY OF THE INVENTION

A computer system for dynamically controlling a thermoset three-dimensional (3D) printer may comprise one or more processors and one or more computer-readable media having stored thereon executable instructions that when executed by the one or more processors configure the computer system to perform various acts. The computer system may receive an indication of one or more thermoset materials that are to be used by the thermoset 3D printer to print a target object. The computer system may also access a materials attribute dataset. The material attribute dataset describes different material properties of the one or more thermoset materials during printing. Based upon the materials attribute dataset, the computer system may determine a particular extrusion configuration for the one or more thermoset materials, and generate a command to cause the thermoset 3D printer to implement the particular extrusion and printing Configuration, such as (but not limited to) how the dispenser is moving, while printing the target object.

Additionally, a computer-implement method for dynamically controlling printing parameters within a thermoset 3D printer may be executed on one or more processors. The computer-implement method may comprise receiving an indication of one or more thermoset materials that are to be used by the thermoset 3D printer to print a target object. Additionally, the computer-implement method may comprise accessing a material attribute dataset. The materials attribute dataset describes different material properties of the one or more thermoset materials during printing. The computer-implemented method may also comprise, based upon the materials attribute dataset, determining a particular extrusion configuration for the one or more thermoset materials, and generating a command to cause the thermoset 3D printer to implement the particular extrusion configuration while printing the target object.

Further, a computer-readable medium may comprise one or more physical computer-readable storage media having stored thereon computer-executable instructions. When the computer-executable instructions are executed at a one or more processors, the computer-executable instructions may cause a computer system to perform a method for dynamically controlling printing parameters within a thermoset 3D printer. The executed method may comprise receiving an indication of one or more thermoset materials that are to be used by the thermoset 3D printer to print a target object. Additionally, the executed method may comprise accessing a material attribute dataset. The materials attribute dataset describes different material properties of the one or more thermoset materials during printing. The executed method may also comprise determining a particular extrusion configuration for the one or more thermoset materials based upon the materials attribute dataset, and generating a command to cause the thermoset 3D printer to implement the particular extrusion configuration while printing the target object.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific configurations thereof, which are illustrated in the appended drawings. Understanding that these drawings depict only typical configurations of the invention and are not therefore to be considered to be limiting of its scope, the invention will be described and explained with additional specificity and detail through the use of the accompanying drawings.

FIG. 1 illustrates a system for thermoset 3D printing.

FIG. 2 illustrates a schematic of a computer system for thermoset 3D printing.

FIG. 3 illustrates a side view of different bead sizes.

FIG. 4A illustrates an example of an extrusion configuration that has a first cross-sectional diameter, a first extrusion volume for each bead, and a particular extrusion speed.

FIG. 4B illustrates an example of an extrusion configuration that has the first cross-sectional diameter, a second extrusion volume for each bead that is smaller than the first extrusion volume, and a particular extrusion speed.

FIG. 4C illustrates an example of an extrusion configuration that has a second cross-sectional diameter that is smaller than the first cross-sectional diameter, a third extrusion volume for each bead, and a particular extrusion speed.

FIG. 4D illustrates an example of an extrusion configuration that has the second cross sectional diameter, a fourth extrusion volume for each bead that is smaller than the third extrusion volume, and a particular extrusion speed.

FIGS. 5A-5C illustrates an example of printing a 3D object based upon a particular extrusion configuration that implements varying slicing diameters.

FIG. 6 illustrates a method for dynamically controlling a thermoset printer to create desired material attributes.

### DETAILED DESCRIPTION OF THE PREFERRED CONFIGURATIONS

The present invention extends to systems, methods, and apparatuses for dynamically controlling a thermoset three-dimensional (3D) printer. The systems, methods, and apparatuses operate through the deposition of coreactive materials during the creation of a target object. As used here, a “target object” may refer to a portion of a physical object or a complete physical object that is being additively manufactured by the systems, method, and/or apparatuses described here. Additionally, as used herein coreactive materials comprise thermoset materials.

Additive manufacturing using coreactive components has several advantages compared to alternative additive manufacturing methods. As used herein, “additive manufacturing” refers to the use of computer-aided design (e.g., through user generated files or 3D object scanners) to cause an additive manufacturing apparatus to deposit material, layer upon layer, in precise geometric shapes. Additive manufacturing using coreactive components can create stronger parts because the materials forming successive layers can be coreacted to form covalent bonds between the layers. Also, because the components have a low viscosity when mixed, higher filler content can be used. The higher filler content can be used to modify the mechanical and/or electrical properties of the materials and the built target object. Coreactive components can extend the chemistries used in additively manufactured parts to provide improved properties such as solvent resistance and thermal resistance.

Additionally, the ability to use a computer system to control the use of coreactive components within an additive manufacturing environment provides several advantages. For example, the computer system is able to dynamically control and adjust the flow rates and tool paths of the coreactive components in ways that produce desired physical attributes of the resulting material. Such adjustments and control provide unique advantages within additive manufacturing.

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to comprise all sub-ranges subsumed therein. For example, a range of “1 to 10” is intended to comprise all sub-ranges between (and including) the recited minimum value of 1 and the recited maximum value of 10, that is, having a minimum value equal to or greater than 1 and a maximum value of equal to or less than 10.

The use of the singular comprises the plural and plural encompasses singular, unless specifically stated otherwise. In addition, the use of “or” means “and/or” unless specifically stated otherwise, even though “and/or” may be explicitly used in certain instances.

The term “polymer” is meant to comprise prepolymer, homopolymer, copolymer, and oligomer.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Configurations of the present disclosure are directed to the production of structural objects using 3D printing. A 3D object may be produced by forming successive portions or layers of an object by depositing at least two coreactive components onto a substrate and thereafter depositing additional portions or layers of the object over the underlying deposited portion or layer. Layers are successively deposited to build the 3D printed object. The coreactive components can be mixed and then deposited or can be deposited separately. When deposited separately, the components can be deposited simultaneously, sequentially, or both simultaneously and sequentially.

Deposition and similar terms refer to the application of a printing material comprising a coreactiveting or coreactive composition and/or its reactive components onto a substrate (for a first portion of the object) or onto previously deposited portions or layers of the object. Each coreactive component may comprise monomers, prepolymers, adducts, polymers, and/or crosslinking agents, which can chemically react with the constituents of the other coreactive component.

The at least two coreactive components may be mixed together and subsequently deposited as a mixture of coreactive components that react to form portions of the object. For example, the two coreactive components may be mixed together and deposited as a mixture of coreactive components that react to form the coreactivating composition by delivery of at least two separate streams of the coreactive components into a mixing apparatus such as a static mixer or a dynamic mixer to produce a single stream that is then deposited. The coreactive components may be at least partially reacted by the time a composition comprising the reaction mixture is deposited. The deposited reaction mixture may react at least in part after deposition and may also react with previously deposited portions and/or subsequently deposited portions of the object such as underlying layers or overlying layers of the object.

Alternatively, the two coreactive components may be deposited separately from each other to react upon deposition to form the portions of the object. For example, in some embodiments, depending on relative gel times of two coreactive components, a predetermined time is set between the two coreactive components are deposited to ensure bonding between multiple layers. For example, the two coreactive components may be deposited separately such as by using an inkjet printing system whereby the coreactive components are deposited overlying each other and/or adjacent to each other in sufficient proximity so the two reactive components may react to form the portions of the object. As another example, in an extrusion, rather than being homogeneous, a cross-sectional profile of the extrusion may be inhomogeneous such that different portions of the cross-sectional profile may have one of the two coreactive components and/or may contain a mixture of the two coreactive components in a different molar and/or equivalents ratio.

Furthermore, throughout a 3D-printed object, different parts of the object may be formed using different proportions of the two or more coreactive components such that different parts of an object may be characterized by different material properties. In some embodiments, a five in one print head may be implemented to simultaneously eject five different proportions of different coreactive components. For example, some parts of an object may be rigid and other parts of an object may be flexible.

It will be appreciated that the viscosity, temperature, reactive time, reaction rate, and other properties of the coreactive components, such as (but not limited to) gel time, sag, flow properties and/or rheology, yield stress, high viscosity, non leveling, ooze, aero shear viscosity, A/B compatibility, may be adjusted to control the flow of the coreactive components and/or the coreactiveting compositions such that the deposited portions and/or the object achieves and retains a desired structural integrity following deposition. The viscosity of the coreactive components may be adjusted by the inclusion of a solvent, or the coreactive components may be substantially free of a solvent or completely free of a solvent. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or ink jetting. The viscosity may be affected by the composition of the coreactive components themselves and/or may be controlled by the inclusion of rheology modifiers as described herein.

It can be desirable that the viscosity and/or the reaction rate be such that following deposition of the coreactive components the composition retains an intended shape. For example, if the viscosity is too low and/or the reaction rate is too slow a deposited composition may flow in a way the compromises the desired shape of the finished object. Similarly, if the viscosity is too high and/or the reaction rate is too fast, the desired shape may be compromised.

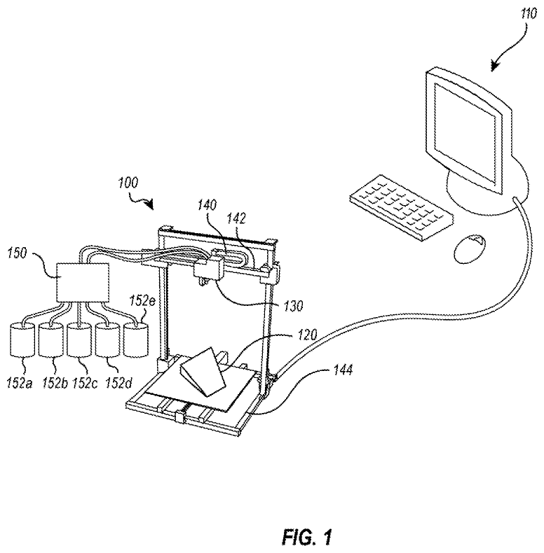

Turning now to the figures, FIG. 1 illustrates a system for 3D printing using coreactive components. The depicted system comprises a 3D printer 100 in communication with a computer system 110. While depicted as a physically separate component, the computer system 110 may also be wholly integrated within the 3D printer 100, distributed between multiple different electronic devices (including a cloud computing environment), or otherwise integrated with the 3D printer 100. As used herein, a “3D printer,” refers to any device capable of additive manufacture using computer-generated data files. Such computer-generated data files herein are referred to as “CAD files.”

The depicted 3D printer 100 is depicted with a target object 120 in the form of a wedge shape. The wedge shape is constructed by the 3D printer 100 using, at least in part, coreactive components. The 3D printer 100 also comprises a dispenser 130 that is attached to a movement mechanism 140. As used herein, a “dispenser” may comprise a dynamic nozzle, a static nozzle, a static mixing nozzle, injection device, a pouring device, a dispensing device, an extrusion device, a spraying device, or any other device capable of providing a controlled flow of coreactive components.

Additionally, the movement mechanism 140 is depicted as comprising a dispenser attached within a track 142 that is moveable in an X-axis direction along an arm and another set of tracks 144 in which the arm is able to move in a Y-axis direction. In some embodiments, the tracks 142, 144 and/or additional tracks may be configured to move in Z-axis direction. One will appreciate, however, that this configuration is provided only for the sake of example and explanation. In additional or alternative configurations, the movement mechanism 140 may comprise any system that is capable of controlling a position of the dispenser 130 with respect to a target object 120, including, but not limited to a system that causes the target object 120 to move with respect to the dispenser 130.

Further, the 3D printer 100 is connected to one or more containers 152(a-e) of coreactive components. In the depicted example, the coreactive components are accessed through a selectable manifold 150 that allows a user to select the desired containers 152(a-e) from which to draw coreactive components. One will appreciate, however, that the depicted system for 3D printing is merely exemplary. For example, in alternative cases the system may comprise a different configuration of coreactive components and the selectable manifold 150 or may not comprise a selectable manifold 150 at all.

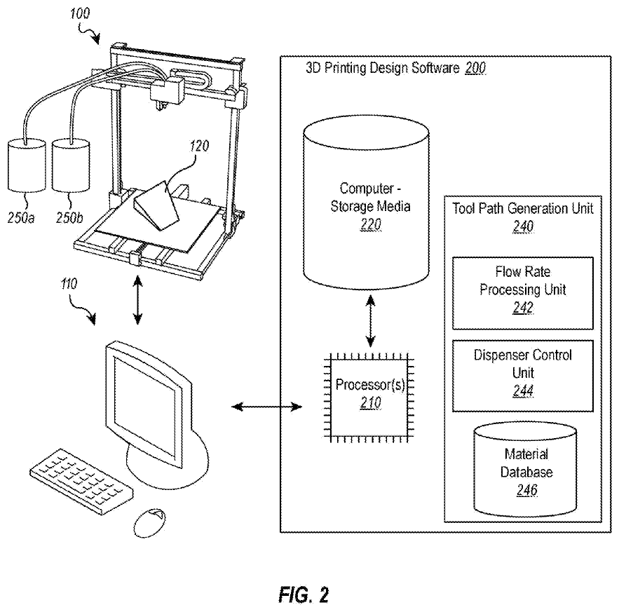

FIG. 2 illustrates a schematic of a computer system for thermoset 3D printing. The computer system 110 is shown as being in communication with the 3D printer 100. Additionally, various modules, or units, of a 3D Printing design software 200 are depicted as being executed by the computer system 110. In particular, the 3D Printing design software 200 is depicted as comprising a tool path generation unit 240, a flow rate processing unit 242, a dispenser control unit 244, and a material database 246. In some embodiments, the flow rate processing unit 242 may be configured to turn on and/or off one or more valves at the dispenser 130, and/or control flow rate based on E commands (which invoke a system editor to edit statements in a stack). In some embodiments, the dispenser control unit 244 may be configured to control a linear movement of the dispenser 130.

The depicted computer system for thermoset 3D printing is further shown as comprising a first coreactive component container 150a and a second coreactive component container 150b that are directly fed into the 3D printer 100. As such, the 3D printer 100 can extract coreactive components as desired from the first coreactive component container 150a and the second coreactive component container 150b. One will appreciate, however, that this configuration is merely exemplary and that in additional or alternative configurations a different configuration of coreactive component containers may be utilized to provide coreactive components to the 3D printer 100.

As used herein, a “module” comprises computer executable code and/or computer hardware that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any particular structure of computer executable code and/or computer hardware is required, unless expressly stated otherwise. In this description, the terms “unit”, “component”, “agent”, “manager”, “service”, “engine”, “virtual machine” or the like may also similarly be used.

The computer system 110 also comprises one or more processors 210 and one or more computer-storage media 220 having stored thereon executable instructions that when executed by the one or more processors 210 configure the computer system 110 to perform various acts. For example, the computer system 110 can receive an indication to cause the 3D printer 100 to print a layer. As used herein, an “indication” comprises any form of input received by the computer system 110. For example, the indication may comprise manual entry by a user, automatic actions executed by the computer system 110 or another remote computer system, the execution of a software application, the selection of a user interface element within a graphical user interface, the receipt of a data file, or any other form of input that causes the computer system 110 to perform a further action.

Once the indication to print a layer of the target object 120 is received by the computer system 110, the tool path generation unit 240 generates a tool path to additively manufacture the target object 120 and/or accesses materials database for generating the toolpath with specific properties of the material. As used herein, a “tool path” refers to the path of the dispenser 130 as it manufactures the target object 120. Additionally, the “tool path” may also refer to the speed and/or flow rate of the dispenser 130 as it manufactures the target object 120. The tool path generation unit 240 generates the tool path such that the coreactive material is dispensed from the dispenser 130 at a rate and along a path that will create the target object 120.

In some circumstances, the tool path may require the dispenser 130 to layer coreactive material in layers on top of themselves. The flow rate processing unit 242 calculate a target flowrate to ensure that the coreactive material properly bonds between the different layers. Such calculations may account for the reactive time of the coreactive material such that the layers are placed on top of each other before lower layers have time to fully cure. As such, the generation of the first tool path may be based, at least in part, upon the target flow rate. As explained above, such information relating to the amount of time that different coreactive components remain reactive is provided by the material database 246.

As used herein, the “flow rate” (also referred to as “extrusion rate”) comprises the rate at which one or more components of the material are dispensed from the dispenser 130. The flow rate may be controllable on a per-component basis. For example, the tool path generation unit 240 comprises a flow rate processing unit 242 that determines and controls the target flow rate for dispensing coreactive material to create the target object 120. In some embodiments, the flow rate processing unit 242 may be configured to turn on and/or off one or more valves at the dispenser 130, and/or control flow rate based on E commands (which invoke a system editor to edit statements in a stack). In some embodiments, the dispenser control unit 244 may be configured to control a linear movement of the dispenser 130.

The flow rate processing unit 242 may be configured to manipulate the flow rate of the coreactive material by changing properties of the coreactive components within the coreactive material while making the target object 120. It will be appreciated that the viscosity, reaction rate, and other properties of the coreactive components may be adjusted to control the flow of the coreactive components and/or the thermosetting compositions such that the deposited portions and/or the object achieves and retains a desired structural integrity following deposition. The viscosity of the coreactive components may be adjusted by the inclusion of a solvent (such as, but not limited to, a resin, a pigment rheology modifier), or the coreactive components may be substantially free of a solvent or completely free of a solvent. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or ink jetting. The viscosity may be affected by the composition of the coreactive components themselves and/or may be controlled by the inclusion of rheology modifiers as described herein.

It can be desirable that the viscosity and/or the reaction rate be such that following deposition of the coreactive components the composition retains an intended shape. For example, if the viscosity is too low and/or the reaction rate is too slow a deposited composition may flow in a way the compromises the desired shape of the finished object. Similarly, if the viscosity is too high and/or the reaction rate is too fast, the desired shape may be compromised.

For example, the coreactive components that are deposited together may each have a viscosity at 25° C. and a shear rate at 0.1 s⁻¹ from 5,000 centipoise (cP) to 5,000,000 cP, from 50,000 cP to 4,000,000 cP, or from 200,000 cP to 2,000,000 cP. The coreactive components that are deposited together may each have a viscosity at 25° C. and a shear rate at 1,000 s⁻¹ from 50 centipoise (cP) to 50,000 cP, from 100 cP to 20,000 cP, or from 200 to 10,000 cP. Viscosity values can be measured using an Anton Paar MCR 301 or 302 rheometer with a gap from 1 mm to 2 mm.

Additionally, the viscosity and/or reaction rate can be adjusted to control the actual bead size, or layer size, that is dispensed by the dispenser 130. As used herein, a “bead” comprise a layer of material dispensed by the dispenser 130 on a tool path. Similarly, as used herein the “bead size” comprises one or more dimensions of a layer that is being dispensed by the dispenser 130. For example, a bead size may comprise a height of the bead, a radius of a bead, a width of a bead, or any other physical dimension of the bead. It will be appreciated that while the word “bead” is used herein, the actual layer need not bear a physical resemblance to a conventional bead shape.

Additionally or alternatively, the dispenser control unit 244 may adjust the characteristics of the 3D printer 100 in order to achieve a desired flow rate. For example, the dispenser control unit 244 may cause the dispenser 130 to travel faster or slower in order to achieve the desired bead size, deposition rate, viscosity, and/or reaction rate. In some embodiments, the dispenser control unit 244 may also cause the dispenser 130 to travel faster or slower, acceleration, jerk, and/or kill deceleration (corresponding to conditions in which the printer decelerates to kill its motion) in order to achieve the desired bead size, deposition rate, viscosity, and/or reaction rate. For example, if the dispenser 130 is dispensing coreactive materials at a constant rate and the dispenser control unit 244 causes the dispenser to travel at a faster speed during deposition, the resulting bead size will be smaller depending on physical materials' properties. Similarly, the dispenser control unit 244 may cause the dispenser 130 to dispense the coreactive material at higher or lower rates based upon a desired flow rate and/or bead size. As such, the flow rate processing unit 242 may adjust the properties of the coreactive components within the material and/or the dispenser control unit 244 may adjust the mechanical operation of the 3D printer 100 in order to achieve a desired flowrate and/or bead size. In some embodiments, a feed forward control mechanism is implemented for compensation at the machine level for coasting, etc. based on print volume, speed, etc., to compensate during printing. In some embodiments, such compensation is not tied to predetermined calculations, but based on layers of object that have been printed.

In some configurations, the 3D printer 100 may be capable of utilizing multiple different types of material to manufacture the target object 120. These different materials may comprise different combination of coreactive components. For example, FIG. 1 depicts one or more containers 152(a-e) of coreactive components that each may comprise a different type of coreactive component. Upon receiving the indication of the material, the tool path generation unit 240 accesses from a material database 246 characteristics of the material. In some cases, the indication of the material comprises a specific mixture of coreactive components, such as a specific mixture of coreactive components provided by the one or more containers 152(a-e) of coreactive components. The characteristics of the material comprise a viscosity of the material and/or various other attributes relating to the reactivity of the material. Using the information from the material database 246 and the processes described above, the tool path generation unit 240 determines the target flow rate and/or bead size using characteristics of the material.

Additionally, in some configurations, the coreactive components may utilize an external stimulus, such as UV light during the reaction process. In such cases, the 3D printer 100 may comprise a UV light source that is controllable by the computer system 110. The 3D printer 100 may be configurable to dispense the coreactive material and cure the material with a UV light source. Various other stimuli may be similarly implemented by the computer system 110 such that the stimuli are applied to the coreactive material during and/or after the dispensing of the coreactive material. In some embodiments, other equipment adjustments may be implemented to adjust other properties of the coreactive components. For example, viscosity properties may be changed by adjusting pressure set points; flow properties may be changed by adjusting pump rotation speed; gel time may be changed by adjusting gantry speed, flow properties or part geometry may be changed by adjusting nozzle diameter and mixing configuration, etc. For example, for a progressive cavity pump based extruder, different materials require the motors of the extruder to pump more slowly or more quickly in order to achieve the same target pumping rate. In some embodiments, the rotation rate of the motor may also be a material-dependent pumping attribute.

Returning now to the dynamically controlling printing parameters within the thermoset 3D printer 100, a user can input an indication at the computer system 110. The indication indicates one or more thermoset materials that are to be used by the thermoset 3D printer 100 to print a target object. In some configurations, the indication may further comprise a ratio of the one or more thermoset materials that are to be used by the thermoset 3D printer 100.

In response to receiving the indication, the 3D printing design software 200 can access a materials attribute dataset 246. The material attribute dataset 246 describes different material properties of the one or more thermoset materials during printing. Since the one or more materials are coreactive components, the material attribute dataset 246 may comprise different material properties of the one or more materials after being mixed, reacted, and/or partially reacted with each other. In some cases, different ratios of the one or more thermoset materials are to be used. In some embodiments, the material properties may comprise (but are not limited to) at least one of an abrasion resistance property, density, thermal expansion, thermal conductivity, chemical resistance, glass transition temperature (Tg), extension at break, surface energy, or electrical conductivity. In some configurations, the particular extrusion configuration accounts for a length of coasting while printing the target 3D object. In yet some other configurations, the particular extrusion configuration accounts for a print speed while printing the target 3D object

For example, the different material properties of the one or more thermoset materials during printing may comprise different flow properties of the one or more thermoset materials during printing. In some cases, the different flow properties of the one or more thermoset materials during printing can cause the particular extrusion configuration to account for an impact of the different flow properties on layer height and width with the extruded one or more thermoset materials. In other cases, the different flow properties of the one or more thermoset materials during printing may also cause the particular extrusion configuration to account for a length of coasting while printing the target 3D object.

As another example, the different properties of the one or more thermoset materials during printing may also comprise different gel properties of the one or more thermoset materials during printing. In some cases, the different gel properties of the one or more thermoset materials during printing may cause the particular extrusion configuration to account for a minimum mixing flow rate while printing the target 3D object. In some other cases, the different gel properties of the one or more thermoset materials during printing may cause the particular extrusion configuration to account for a print speed while printing the target 3D object.

Based upon the materials attribute dataset 246, the 3D printing design software 200 can determine a particular extrusion configuration for the one or more thermoset materials and generate a command to cause the thermoset 3D printer 100 to implement the particular extrusion configuration while printing the target 3D object. In some configurations, the particular extrusion configuration may comprise (but are not limited to) a cross-sectional diameter of a nozzle, an extrusion volume of each bead or liquid drop, and/or an extrusion speed. In some configurations, the particular extrusion configuration may further comprise (but are not limited to) a

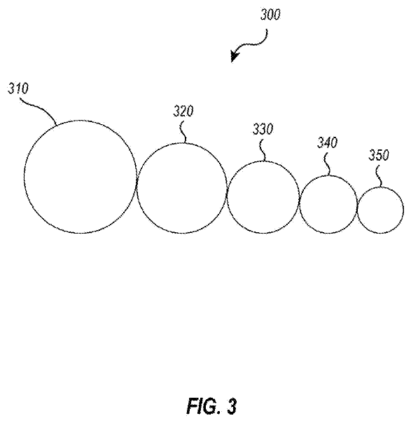

For instance, FIG. 3 illustrates a side view of different bead sizes. In the depicted example, a first bead size 310 may correspond to a first extrusion configuration. The second bead size 320 is smaller than the first set of bead sizes and corresponds to a second extrusion configuration. Similarly, the third bead size 330 is smaller than the second bead size 320 and corresponds to a third extrusion configuration, and so on and so forth. In some configurations, the flow rate processing unit 242 can determine a particular extrusion configuration, which in turn determines one or more bead sizes, based on the one or more thermoset materials that are to be used.

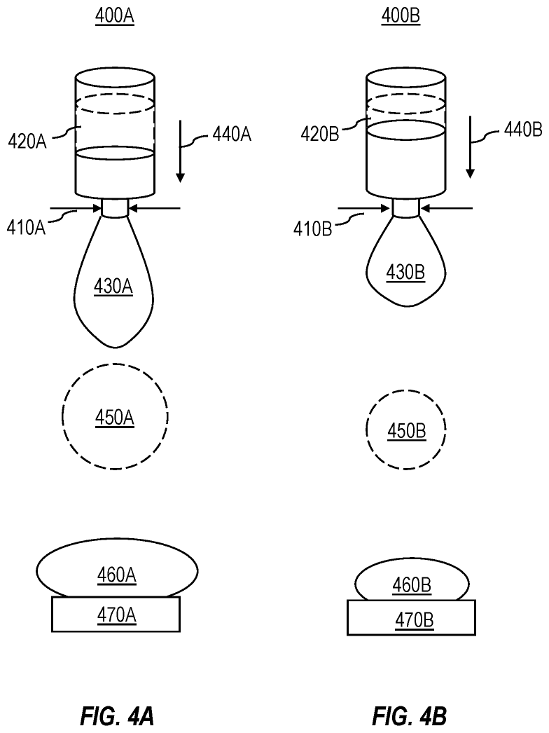

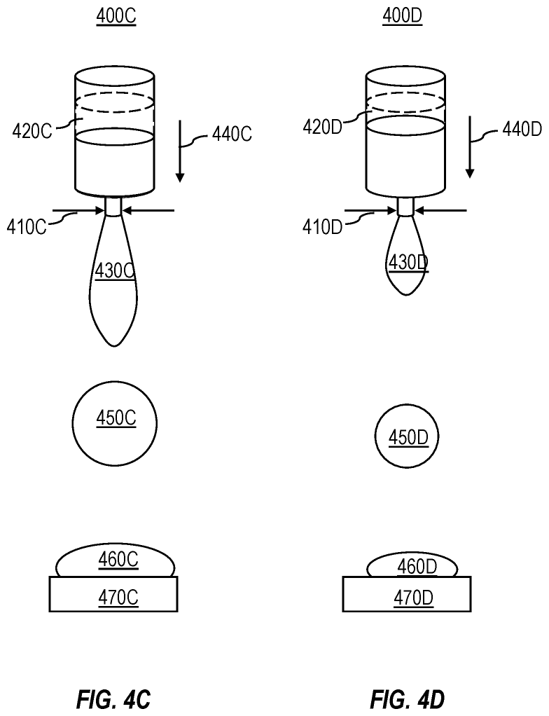

FIGS. 4A-4D further illustrate different examples of extrusion configurations. FIGS. 4A and 4B illustrate two examples of extrusion configurations 400A, 400B, in which a nozzle has a same cross-sectional extrusion diameter 410A and 410B. However, the extrusion volume 420A of a bead in the extrusion configuration 400A is greater than the extrusion volume 420B of a bead in the extrusion configuration 400B. As such, a bead 430A extruded based on the extrusion configuration 400A is greater than a bead 430B extruded based on the extrusion configuration 400B. Further, an extrusion speed 440A in the extrusion configuration 400A may also be different from the extrusion speed 440B in the extrusion configuration 400B.

FIGS. 4C and 4D further illustrate two examples of extrusion configurations 400C, 400D, in which a nozzle has a cross-sectional extrusion diameter 410C, 410D that is smaller than the cross-sectional extrusion diameter 410A, 410B in the configurations 400A, 400B of FIGS. 4A and 4B. Similarly, even though the configurations 400C and 400D share a same extrusion diameter, the extrusion configuration 400C has a greater extrusion volume for each bead than that of the configuration 400D. Also, the extrusion speed 440C of configuration 400C and the extrusion speed 440D of configuration 400D may be same or different from each other, and/or the extrusion speed 440A or 440B of configurations 400A, 400B.

As illustrated, after the bead 430A, 430B, 430C, 430D is extruded out of the nozzle, the extruded bead 450A, 450B, 450C, 450D falls onto a surface 470A, 470B, 470C, 470D to form a portion of a layer 460A, 460B, 460C, 460D. The surface 470A, 470B, 470C, 470D may be a plate where the 3D object is formed when a first layer of the target 3D object is to be formed. Alternatively, the surface 470A, 470B, 470C, 470D may be a previous layer of the target 3D object when a second layer or a later layer of the target 3D object is to be formed.

As illustrated, depending on the extrusion configurations of the 3D printer, the flow properties, and/or the gel properties of the one or more thermoset materials, the layer height and/or width formed by the one or more thermoset materials may be different. In some configurations, the particular extrusion configuration comprises dynamic changes made to mechanical components of thermoset 3D printer. For example, the particular extrusion configuration may comprise dynamically changing a diameter of a nozzle of a particular dispenser 140. As such, the principles described herein allowing the dynamic control of the extrusion configurations of the 3D printer 100 to account for an impact of the different flow properties on layer height and width with the extruded one or more thermoset materials.

For example, if the one or more thermoset materials are highly flowable, the flow rate processing unit 242 may determine that a smaller cross-sectional extrusion diameter and/or a smaller extrusion volume are to be applied. Or if the two or more thermoset materials have different flowabilities, the flow rate processing unit 242 may determine a combined flowability of a mixture of the two or more thermoset materials. Based on the combined flowability of the mixture of the two or more thermoset materials, the flow rate processing unit 242 can then determine a particular cross-sectional extrusion diameter and/or extrusion volume accordingly.

As another example, if the one or more thermoset materials both have a tough gel property, the flow rate processing unit 242 may determine that a higher extrusion speed is to be applied. Similarly, if the two or more thermoset materials have different gel properties, the flow rate processing unit 242 may determine a combined gel property of a mixture of the two or more thermoset materials. Based on the combined gel property of the mixture of the two or more thermoset materials, the flow rate processing unit 242 can then determine an extrusion speed accordingly.

Further, in some configurations, the particular extrusion configuration may comprise slicing parameters that are encoded within a printing file. In some other configurations, the particular extrusion configuration may comprise slicing parameters that are not encoded within a printing file. Slicing parameters are parameters that describe a cross-section of each layer of the 3D target 3D object that is to be formed. For example, certain areas of a 3D object are susceptible to over extrusion, such as (but not limited to) corners and turns. For such areas of the 3D object, the flow rate processing unit 242 may be configured to adjust the extrusion configuration to cause the bead size to be smaller. Similarly, certain areas of a 3D object are susceptible to under extrusion. For such areas of the 3D object, the flow rate processing unit 242 may be configured to adjust the extrusion configuration to cause the bead size to be larger. The ability to control extrusion configurations slice by slice improves printed part ascetics and mechanical integrity.

For example, the 3D printing design software 200 may be configured to generate a printing file based on a user indication. The user indication may comprise (but are not limited to) the one or more thermoset materials and information associated with the target 3D object (e.g., dimensions, shapes, etc.). Based on the user indication, the 3D printing design software 200 may be configured to generate a printing file that is readable by the printer 100. The printing file may comprise slicing parameters configured to slice the target 3D object into layers. The slicing parameters of the printing file may or may not be encoded with the particular extrusion configuration. In some cases, the particular extrusion configuration may or may not be encoded in the printing file. When the particular extrusion configuration is encoded in the printing file, the particular extrusion configuration may comprise the slicing parameters of the target 3D object that are encoded with the printing file. Alternatively, in some configurations, the particular extrusion configuration is not encoded in the printing file, and the particular extrusion configuration may comprise a set of slicing parameters that are separate from those encoded in the printing file.

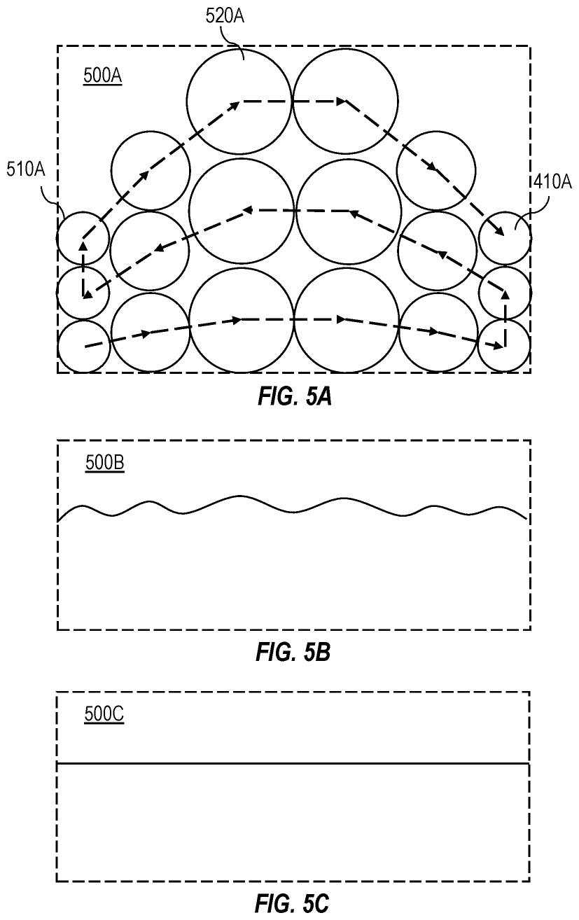

FIG. 5A illustrates an example of printing a target 3D object using a particular extrusion configuration that implements varying extrusion rates based on the printing file and/or the one or more materials. As illustrated, the corner portions 510A of the target 3D object are set to have a smaller slicing diameter, and the center portion 520A of the target 3D object is sent to have a greater slicing diameter. FIGS. 5B-5C illustrate that the extruded material drops of FIG. 5A are merging together to form the target 3D object that has a substantially flat surface.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

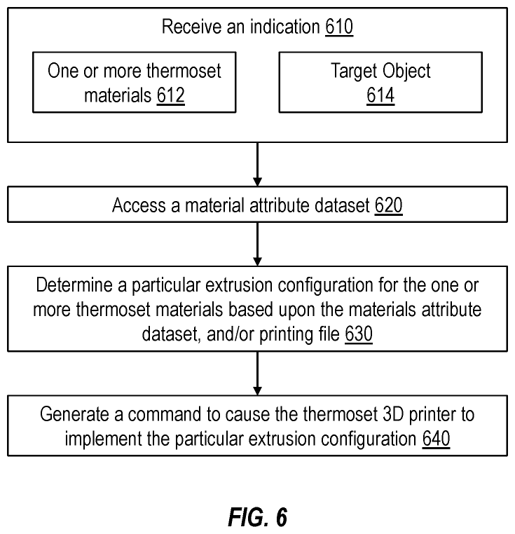

FIG. 6 illustrates a flowchart of steps for a method 600 for dynamically controlling a thermoset printer to create desired material attributes. The method 600 comprises receiving an indication (act 610). The indication may be input by a user at a computer system 110. The indication comprises one or more thermoset materials 612 that are to be used by the thermoset three-dimensional printer to print a target object. The indication may also comprise information associated with the target 3D object 514 (e.g., the shape and/or dimension of the target 3D object). The method 500 further comprises accessing a material attribute dataset (act 520). The materials attribute dataset describes different material properties of the one or more thermoset materials during printing. The material properties may comprise (but are not limited to) flow properties and/or gel properties. The method 600 further comprises determining a particular extrusion configuration for the one or more thermoset materials based upon the materials attribute dataset and/or the shape and/or dimensions of the target 3D object (act 630) and generating a command to cause the thermoset 3D printer to implement the particular extrusion configuration while printing the target object. In some embodiments, a feed forward control mechanism is implemented for compensation at the machine level for coasting, etc. based on print volume, speed, etc., to compensate during printing. In some embodiments, such compensation is not tied to predetermined calculations, but based on layers of object that have been printed.

In some configurations, the particular extrusion configuration accounts for an impact of the different flow properties on layer height and width of the extruded one or more thermoset materials. In some configurations, the particular extrusion configuration accounts for a length of coasting as well as aspect ratio while printing the target object. In some other configurations, the particular extrusion configuration accounts for a print speed while printing the target object.

Further, in some other configurations, the particular extrusion configuration comprises slicing parameters that are encoded with a printing file. In some configurations, the particular extrusion configuration comprises slicing parameters that are not encoded within a printing file. In yet some other configurations, the particular extrusion configuration comprises dynamic changes made to a mechanical component of the thermoset 3D printer (e.g., nozzle diameter) as well as dynamic pressure control.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that comprises computer hardware, such as, for example, one or more processors and system memory, as discussed in greater detail below. Configurations within the scope of the present invention also comprise physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, configurations of the invention can comprise at least two distinctly different kinds of computer-readable media: computer storage media and transmission media.

Computer storage media are physical storage media that store computer-executable instructions and/or data structures. Physical storage media comprise computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can comprise a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be comprised within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be comprised in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may comprise a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“laaS”). The cloud-computing model may also be deployed using different deployment models such as private cloud, community cloud, public cloud, hybrid cloud, and so forth.

Some configurations, such as a cloud-computing environment, may comprise a system that comprises one or more hosts that are each capable of running one or more virtual machines. During operation, virtual machines emulate an operational computing system, supporting an operating system and perhaps one or more other applications as well. In some configurations, each host comprises a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The invention is further exemplified by the following aspects.

In a first aspect, a computer system for dynamically controlling printing parameters within a thermoset three-dimensional printer is provided, comprising: one or more processors, and one or more computer-readable media having stored thereon executable instructions that when executed by the one or more processors configure the computer system to perform at least the following: receive an indication of one or more thermoset materials that are to be used by the thermoset three-dimensional printer to print a target object; access a materials attribute dataset, wherein the materials attribute dataset describes different material properties of the one or more thermoset materials during printing; based upon the materials attribute dataset, determine a particular extrusion configuration for the one or more thermoset materials; and generate a command to cause the thermoset three-dimensional printer to implement the particular extrusion configuration while printing the target object.

According to a second aspect of the system for dynamically controlling printing parameters within a thermoset three-dimensional printer as recited in aspect one the different material properties of the one or more thermoset materials during printing comprise different flow properties of the one or more thermoset materials during printing.

According to a third aspect of the system for dynamically controlling printing parameters within a thermoset three-dimensional printer as recited in any of aspects one through two the particular extrusion configuration includes one or more motion control parameters, including at least one of acceleration, deceleration, jerk, or kill deceleration.

According to a fourth aspect of the system for dynamically controlling printing parameters within a thermoset three-dimensional printer as recited in any of aspects one through three the different flow properties of the one or more thermoset materials during printing cause the particular extrusion configuration to account for an impact of the different flow properties on layer height and width of the extruded one or more thermoset materials.

According to a fifth aspect of the system for dynamically controlling printing parameters within a thermoset three-dimensional printer as recited in any of aspects one through four the different flow properties of the one or more thermoset materials during printing cause the particular extrusion configuration to account for a length of coasting while printing the target object.

According to a sixth aspect of the system for dynamically controlling printing parameters within a thermoset three-dimensional printer as recited in any of aspects one through five the different material properties of the one or more thermoset materials during printing comprise different gel properties of the one or more thermoset materials during printing.

According to a seventh aspect of the system for dynamically controlling printing parameters within a thermoset three-dimensional printer as recited in any of aspects one through sixth the different gel properties of the one or more thermoset materials during printing cause the particular extrusion configuration to account for a minimum mixing flow rate while printing the target object.

According to an eighth aspect of the system for dynamically controlling printing parameters within a thermoset three-dimensional printer as recited in any of aspects one through seven the different gel properties of the one or more thermoset materials during printing cause the particular extrusion configuration to account for a print speed and/or extrusion rate while printing the target object.

According to a ninth aspect of the system for dynamically controlling printing parameters within a thermoset three-dimensional printer as recited in any of aspects one through eight the materials attribute dataset includes a dataset that dictates linear speed for layer time and time in nozzle of the thermoset three-dimensional printer.

According to a tenth aspect of the system for dynamically controlling printing parameters within a thermoset three-dimensional printer as recited in any or aspects one through nine the material attribute dataset includes a dataset that dictates a configuration associated with a pressure of nozzle of the thermoset three-dimensional printer or instructs a user to use a specific static nozzle.

According to an eleventh aspect of the system for dynamically controlling printing parameters within a thermoset three-dimensional printer as recited in any of aspects one through ten the material attribute dataset includes a dataset that dictates configurations associated with gantry, pumping, or UV cure of the thermoset three-dimensional printer.

In a twelfth aspect, a computer-implement method for dynamically controlling a thermoset printer to create desired material attributes, the computer-implemented method executed on one more processor, the method comprising: receiving an indication of one or more thermoset materials that are to be used by the thermoset three-dimensional printer to print a target object; accessing a materials attribute dataset, wherein the materials attribute dataset describes different material properties of the one or more thermoset materials during printing; based upon the materials attribute dataset, determining a particular extrusion configuration for the one or more thermoset materials; and generating a command to cause the thermoset three-dimensional printer to implement the particular extrusion configuration while printing the target object.

According to a thirteenth aspect of the computer-implement method for dynamically controlling a thermoset printer to create desired material attributes as recited in aspect twelve the different material properties of the one or more thermoset materials during printing comprise different flow properties of the one or more thermoset materials during printing.

According to a fourteenth aspect of the computer-implement method for dynamically controlling a thermoset printer to create desired material attributes as recited in any of aspects twelve through thirteen the particular extrusion configuration includes one or more motion control parameters, including at least one of acceleration, deceleration, jerk, or kill deceleration.

According to a fifteenth aspect of the computer-implement method for dynamically controlling a thermoset printer to create desired material attributes as recited in any of aspects twelve through fourteen the different flow properties of the one or more thermoset materials during printing cause the particular extrusion configuration to account for an impact of the different flow properties on layer height and width of the extruded one or more thermoset materials.

According to a sixteenth aspect of the computer-implement method for dynamically controlling a thermoset printer to create desired material attributes as recited in any of aspects twelve through fifteen the different flow properties of the one or more thermoset materials during printing cause the particular extrusion configuration to account for a length of coasting while printing the target object.

According to a seventeenth aspect of the computer-implement method for dynamically controlling a thermoset printer to create desired material attributes as recited in any of aspects twelve through sixteen the different material properties of the one or more thermoset materials during printing comprise different gel properties of the one or more thermoset materials during printing.

According to a eighteenth aspect of the computer-implement method for dynamically controlling a thermoset printer to create desired material attributes as recited in any of aspects twelve through seventeen the different gel properties of the one or more thermoset materials during printing cause the particular extrusion configuration to account for a minimum mixing flow rate while printing the target object.

According to an nineteenth aspect of the computer-implement method for dynamically controlling a thermoset printer to create desired material attributes as recited in any of aspects twelve through eighteen the different gel properties of the one or more thermoset materials during printing cause the particular extrusion configuration to account for a print speed while printing the target object.

According to an twentieth aspect, a computer-readable media comprising one or more physical computer-readable storage media having stored thereon computer-executable instructions that, when executed at a processor, cause a computer system to perform a method for dynamically controlling a thermoset printer to create desired material attributes, the method comprising: receiving an indication of one or more thermoset materials that are to be used by the thermoset three-dimensional printer to print a target object; accessing a materials attribute dataset, wherein the materials attribute dataset describes different material properties of the one or more thermoset materials during printing; based upon the materials attribute dataset, determining a particular extrusion configuration for the one or more thermoset materials; and generating a command to cause the thermoset three-dimensional printer to implement the particular extrusion configuration while printing the target object.

The present invention may be embodied in other specific forms without departing from its spirit or essential characteristics. The described configurations are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A computer system for dynamically controlling printing parameters within a thermoset three-dimensional printer, comprising:
one or more processors; and
one or more computer-readable media having stored thereon executable instructions that when executed by the one or more processors configure the computer system to perform at least the following:
receive an indication of one or more thermoset materials that are to be used by the thermoset three-dimensional printer to print a target object;
access a materials attribute dataset, wherein the materials attribute dataset describes different material properties of the one or more thermoset materials during printing;
based upon the materials attribute dataset, determine a particular extrusion configuration for the one or more thermoset materials; and
generate a command to cause the thermoset three-dimensional printer to implement the particular extrusion configuration while printing the target object.

22. The computer system of claim 21, wherein the different material properties of the one or more thermoset materials during printing comprise different flow properties of the one or more thermoset materials during printing.

23. The computer system of claim 1, wherein the particular extrusion configuration includes one or more motion control parameters, including at least one of acceleration, deceleration, jerk, or kill deceleration.

24. The computer system of claim 22, wherein the different flow properties of the one or more thermoset materials during printing cause the particular extrusion configuration to account for an impact of the different flow properties on layer height and width of the extruded one or more thermoset materials.

25. The computer system of claim 22, wherein the different flow properties of the one or more thermoset materials during printing cause the particular extrusion configuration to account for a length of coasting while printing the target object.

26. The computer system of claim 21, wherein the different material properties of the one or more thermoset materials during printing comprise different gel properties of the one or more thermoset materials during printing.

27. The computer system of claim 26, wherein the different gel properties of the one or more thermoset materials during printing cause the particular extrusion configuration to account for a minimum mixing flow rate while printing the target object.

28. The computer system of claim 26, wherein the different gel properties of the one or more thermoset materials during printing cause the particular extrusion configuration to account for a print speed and/or extrusion rate while printing the target object.

29. The computer system of claim 21, wherein the materials attribute dataset includes a dataset that dictates linear speed for layer time and time in nozzle of the thermoset three-dimensional printer.

30. The computer system of claim 21, wherein the material attribute dataset includes a dataset that dictates a configuration associated with a pressure of nozzle of the thermoset three-dimensional printer or instructs a user to use a specific static nozzle.

31. The computer system of claim 21, wherein the material attribute dataset includes a dataset that dictates configurations associated with gantry, pumping, or UV cure of the thermoset three-dimensional printer.

32. A computer-implement method for dynamically controlling a thermoset printer to create desired material attributes, the computer-implemented method executed on one more processor, the method comprising:
receiving an indication of one or more thermoset materials that are to be used by the thermoset three-dimensional printer to print a target object;
accessing a materials attribute dataset, wherein the materials attribute dataset describes different material properties of the one or more thermoset materials during printing;
based upon the materials attribute dataset, determining a particular extrusion configuration for the one or more thermoset materials; and
generating a command to cause the thermoset three-dimensional printer to implement the particular extrusion configuration while printing the target object.

33. The computer-implement method of claim 12, wherein the different material properties of the one or more thermoset materials during printing comprise different flow properties of the one or more thermoset materials during printing.

34. The computer-implement method of claim 12, wherein the particular extrusion configuration includes one or more motion control parameters, including at least one of acceleration, deceleration, jerk, or kill deceleration.

35. The computer-implement method of claim 12, wherein the different flow properties of the one or more thermoset materials during printing cause the particular extrusion configuration to account for an impact of the different flow properties on layer height and width of the extruded one or more thermoset materials.

36. The computer-implement method of claim 12, wherein the different flow properties of the one or more thermoset materials during printing cause the particular extrusion configuration to account for a length of coasting while printing the target object.

37. The computer-implement method of claim 12, wherein the different material properties of the one or more thermoset materials during printing comprise different gel properties of the one or more thermoset materials during printing.

38. The computer-implement method of claim 17, wherein the different gel properties of the one or more thermoset materials during printing cause the particular extrusion configuration to account for a minimum mixing flow rate while printing the target object.

39. The computer-implement method of claim 17, wherein the different gel properties of the one or more thermoset materials during printing cause the particular extrusion configuration to account for a print speed while printing the target object.

40. A computer-readable media comprising one or more physical computer-readable storage media having stored thereon computer-executable instructions that, when executed at a processor, cause a computer system to perform a method for dynamically controlling a thermoset printer to create desired material attributes, the method comprising:
receiving an indication of one or more thermoset materials that are to be used by the thermoset three-dimensional printer to print a target object;
accessing a materials attribute dataset, wherein the materials attribute dataset describes different material properties of the one or more thermoset materials during printing;
based upon the materials attribute dataset, determining a particular extrusion configuration for the one or more thermoset materials; and
generating a command to cause the thermoset three-dimensional printer to implement the particular extrusion configuration while printing the target object.
